(19) United States
(12) Patent Application Publication
(10) Pub. No.: US 2012/0017345 A1
(43) Pub. Date: Jan. 26, 2012

(54) TURNOUT PANTS WITH PROTECTIVE MATERIAL

(75) Inventors: Jasen Stensgaard, Troutdale, OR (US); Steven Lakey, JR., Portland, OR (US)

(73) Assignee: Jasen Stensgaard, Troutdale, OR (US)

(21) Appl. No.: 12/840,502

(22) Filed: Jul. 21, 2010

(51) Int. Cl. A41D 13/06; A62B 17/00; A41D 13/00; A41D 1/06

(52) U.S. Cl. 2/24; 2/227; 2/81; 2/82

(57) ABSTRACT

Turnout pants for use in firefighting, a protective accessory that can be added to turnout pants and a method of altering turnout pants to protect a wearer from sharp instruments are disclosed herein. Turnout pants may include two pants legs made at least partially of fireproof material. A piece of protective material may be positioned on one or more pants legs. The piece of protective material may be configured to protect a wearer from a sharp instrument such as a chainsaw.

### BACKGROUND

Turnout pants are often worn by firefighters because of their flame-resistant properties. For example, many turnout pants are constructed partially or completely from Nomex®, which is a heat and flame resistant fiber.

Firefighters may on occasion be required to use sharp instruments such as chainsaws in order to cut through objects and debris. Because emergency situations tend to be unpredictable and chaotic, a firefighter may need to use a chainsaw at an unorthodox angle which may expose the firefighter to more risk than if the chainsaw were being used in a safer environment and as typically would be instructed by a chainsaw manufacturer.

Protective material exists that is configured to seize up a chainsaw blade or other sharp instruments upon contact. For example, U.S. Pat. No. 4,280,342 discloses a protective pad made from a double-knit warp fabric of a synthetic material that resists the cutting effect of a saw blade or other sharp tool. U.S. Pat. No. 5,095,544 describes the use of such material in protective chaps designed for users of chainsaws in the logging industry. Chaps such as those disclosed in the '544 patent are not suitable for firefighting because they do not provide fire resistance, particularly at the back of the wearer's legs.

### SUMMARY

Turnout pants for use in firefighting, a protective accessory for use with turnout pants and a method of altering turnout pants to protect a wearer from sharp instruments such as chainsaws are disclosed herein. Turnout pants may include two pants legs made at least partially of fireproof material. One or more pieces of protective material may be positioned on a first pants leg. The piece(s) of protective material may be configured to protect a wearer from a sharp instrument, such as a chainsaw.

### BRIEF DESCRIPTION OF THE DRAWINGS

FIG. 1 is a view of one embodiment of turnout pants for use in firefighting that include a piece of protective material that is configured to seize up a blade of a chainsaw upon the blade coming into contact with the piece of protective material.

FIG. 2 is a view of an embodiment similar to that of FIG. 1 except that a second piece of protective material is also provided.

FIG. 3 is a view of an embodiment similar to those shown in FIGS. 1 and 2, except that the piece of protective material is sized to extend from an inseam of the turnout pants to the outer seam.

### DETAILED DESCRIPTION

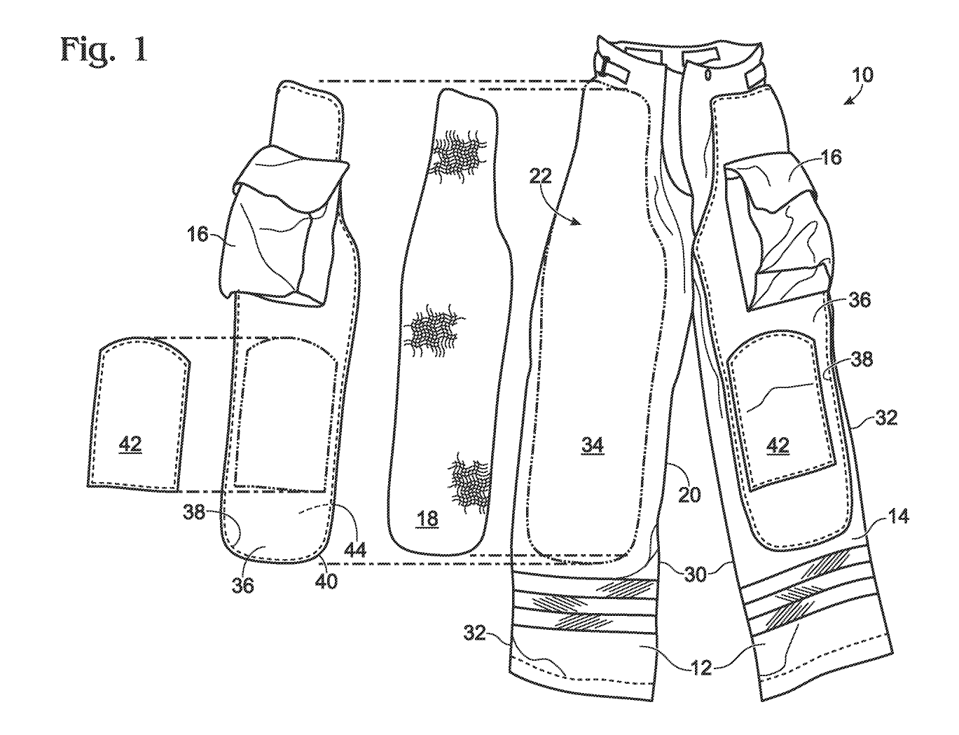

Turnout pants 10 such as those shown in FIGS. 1-3 may be worn by a firefighter or other emergency personnel that require thermal protection. Turnout pants 10 may include two pants legs 12 made at least partially of fireproof material 14. Each pants leg 12 may include any number of pockets 16. Fireproof material 14 may include Nomex® or other similar flame resistant or flameproof materials.

A piece of protective material 18 may be positioned on a first pants leg 20. Piece of protective material 18 may be configured to protect a wearer from a sharp instrument. For example, piece of protective material 18 may be adapted to seize up a chainsaw blade upon the blade coming into contact with piece of protective material 18. Examples of the types of material that may be used to create piece of protective material are described in U.S. Pat. Nos. 4,280,342 and 5,095,544, both which are incorporated herein by reference for all purposes.

In some embodiments, such as that shown in FIG. 1, a single piece of protective material 18 is included with turnout pants 10 and is sized to extend along the majority of the wearer's leg. In other embodiments, multiple pieces of protective material may be positioned on each pants leg 12 of turnout pants 10 at various positions.

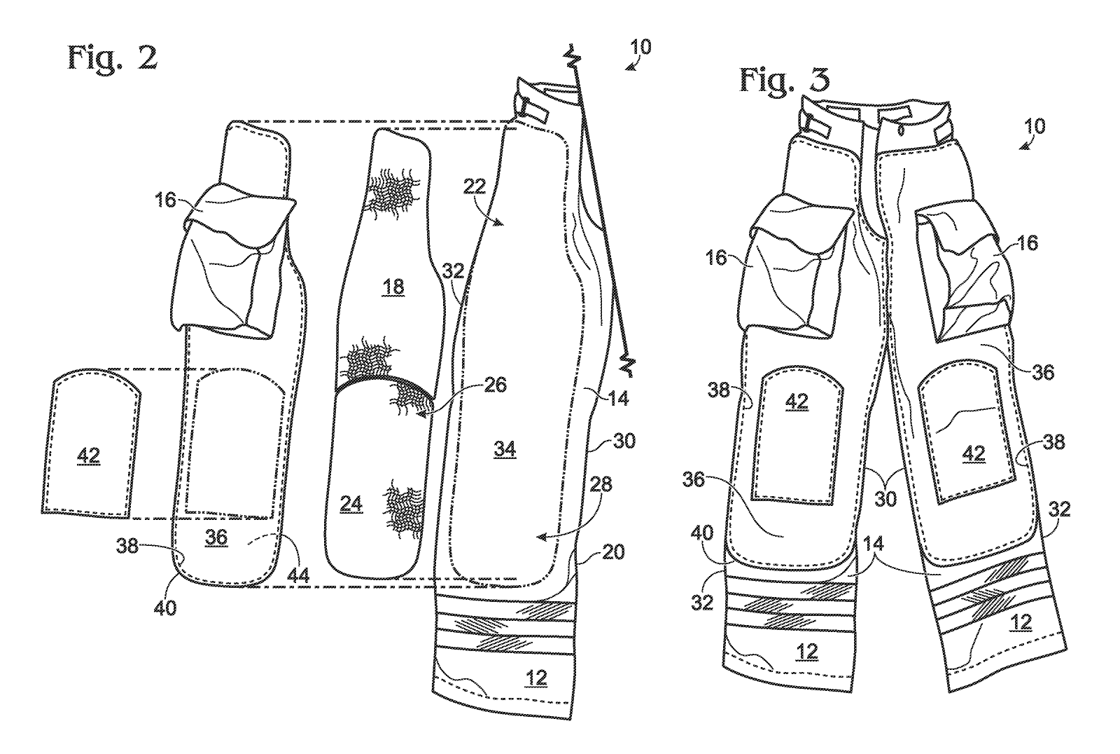

For example, in FIG. 2, one piece of protective material 18 is positioned at a thigh portion 22 of first pants leg 20. A second piece of protective material 24 may be positioned on turnout pants 10 below the first piece of protective material 18 to define an articulating area 26 at the wearer's knee. For example, in FIG. 2 second piece of protective material 24 is positioned at a shin portion 28 of first pants leg 20, and is separate from first piece of protective material 18 positioned at thigh portion 22. The pieces of protective material (18, 24) may be positioned so that there is no space between them or a small amount of spare between them. The separation at articulating area 26 may allow the wearer to bend his or her knee more freely than with embodiments such as FIG. 1 where a single piece of protective material 18 covers the entire front of the wearer's leg.

Pieces of protective material (18, 24) may extend various distances around the wearer's legs. For example, as shown in FIG. 1, piece of protective material 18 that is positioned at thigh portion 22 of first pants leg 20 may be sized to extend less than 180° around a circumference of the wearer's leg. In other embodiments, piece of protective material (18, 24) may be sized to extend approximately 180° around a circumference of the wearer's leg. For example, in FIG. 3 one or more pieces of protective material (18, 24)—which are not visible in FIG. 3 but are contained behind an extra piece of fireproof material 36—may extend from an inseam 30 of first pants leg 20 to an outer seam 32 of first pants leg 20.

In some embodiments, pieces of protective material (18, 24) may be positioned on first pants leg 20 between an outer surface 34 of first pants leg 20 and an extra piece of fireproof material 36 that is sewn onto outer surface 34 of first pants leg 20. Extra piece of fireproof material 36 may include similar materials as fireproof material 14, such as Nomex®. Extra piece of fireproof material 36 may be sewn onto outer surface 34 of first pants leg 20 in order to hold pieces of protective material (18, 24) adjacent to the wearer's leg, so that the wearer's leg is protected from sharp instruments such as chainsaws.

In some embodiments, stitching 38 that attaches extra piece of fireproof material 36 to outer surface 34 of first pants leg 20 also attaches pieces of protective material (18, 24) to extra piece of fireproof material 36 and/or outer surface 34 of first pants leg 20. This maintains piece of protective material 18 in place relative to pants leg 20. In some instances, stitching 38 includes one or more bar tack corners 40 to provide additional stability and durability.

A knee pad 42 may be provided to protect the wearer's knee. In the embodiments shown in FIGS. 1-3, knee pad 42 is affixed to an outer surface of extra piece of fireproof material 36. In the embodiment of FIG. 2, knee pad 42 overlays articulated area 26. In such instances, knee pad 42 may include materials that make it resistant to sharp instruments such as chainsaws.

In some instances, pieces of protective material (18, 24) may have a tendency to absorb liquids. Such a characteristic may be disadvantageous for a firefighter that must utilize water to fight fires. Accordingly, pieces of protective material (18, 24) may be shielded from water. For example, outer surface 34 of first pants leg 20 adjacent extra piece of fireproof material 36 and an inner surface 44 of extra piece of fireproof material 36 may be water resistant or waterproof. This may be accomplished in a number of ways. For example, outer surface 34 of first pants leg 20 adjacent extra piece of fireproof material 36 may be lined with water-proof material. Additionally or alternatively, inner surface 44 of extra piece of fireproof material 36 may be lined with water-proof material.

Existing turnout pants that lack protection from sharp instruments such as chainsaws may be modified to include such protection. For example, pieces of protective material (18, 24), extra piece of fireproof material 36 and knee pad 42 may be packaged together as a protective accessory that can be added to existing turnout pants in order to protect the wearer from sharp instruments.

In some protective accessories, piece of protective material 18 may be attached to extra piece of fireproof material 36 so that it protects thigh portion 22 of the leg when piece of fireproof material 36 is attached to turnout pants 10. A protective accessory may further include a second piece of protective material 24 that is attached to extra piece of fireproof material 36 so that it protects a shin portion 28 of the wearer's leg when piece of fireproof material 36 is attached to turnout pants 10. In some protective accessories, pieces of protective material (18, 24) may be sized to extend approximately 180° around the circumference of the wearer's leg when attached to turnout pants 10 (e.g., from an inseam 30 to an outer seam 32). In other protective accessories, pieces of protective material (18, 24) may be sized to extend less than 180° around the circumference of the wearer's leg when attached to turnout pants 10.

It is believed that the disclosure set forth above encompasses multiple distinct embodiments with independent utility. While each of these embodiments has been disclosed in its preferred form, the specific embodiments thereof as disclosed and illustrated herein are not to be considered in a limiting sense as numerous variations are possible. The subject matter of the disclosure includes all novel and non-obvious combinations and sub-combinations of the various elements, features, functions and/or properties disclosed herein. Similarly, where the disclosure recites “a” or “a first” element or the equivalent thereof, such disclosure should be understood to include incorporation of one or more such elements, neither requiring nor excluding two or more such elements.

Various combinations and sub-combinations of features, functions, elements, and/or properties may be claimed in a related application. Such new claims, whether they are directed to a different invention or directed to the same invention, whether different, broader, narrower or equal in scope to any original claims, are also regarded as included within the subject matter of the present disclosure.

What is claimed is:

1. Turnout pants for use in firefighting, comprising:
two pants legs made at least partially of fireproof material;
a piece of protective material positioned on a first pants leg, the piece of protective material being configured to protect a wearer from a chainsaw.

2. The turnout pants of claim 1, wherein the piece of protective material is adapted to seize up a chainsaw blade upon the blade coming into contact with the piece of protective material.

3. The turnout pants of claim 2, wherein the piece of protective material is positioned at a thigh portion of the first pants leg.

4. The turnout pants of claim 3, further comprising a second piece of protective material that is positioned at a shin portion of the first pants leg.

5. The turnout pants of claim 4, wherein the piece of protective material that is positioned at the thigh portion of the first pants leg is sized to extend approximately 180° around a circumference of the wearer's leg.

6. The turnout pants of claim 1, wherein the piece of protective material extends from an inseam of the first pants leg to an outer seam of the first pants leg.

7. The turnout pants of claim 1, wherein the piece of protective material is positioned on the first pants leg between an outer surface of the first pants leg and an extra piece of fireproof material that is sewn onto the outer surface of the first pants leg.

8. The turnout pants of claim 7, wherein a knee pad is affixed to an outer surface of the extra piece of fireproof material.

9. The turnout pants of claim 7, wherein the outer surface of the first pants leg adjacent the extra piece of fireproof material and an inner surface of the extra piece of fireproof material are water resistant.

10. The turnout pants of claim 7, wherein the outer surface of the first pants leg adjacent the extra piece of fireproof material and an inner surface of the extra piece of fireproof material are lined with water-proof material.

11. The turnout pants of claim 7, wherein stitching that attaches the extra piece of fireproof material to the outer surface of the first pants leg includes a bar tack corner.

12. The turnout pants of claim 11, wherein stitching that attaches the extra piece of fireproof material to the outer surface of the first pants leg also attaches the piece of protective material to the extra piece of fireproof material and the outer surface of the first pants leg.

13. A protective accessory for attachment to turnout pants for use in firefighting, comprising:
a piece of fireproof material adapted to be attached to a leg of the turnout pants; and
a piece of protective material that is attached to the piece of fireproof material and is configured to protect a wearer from a chainsaw.

14. The protective accessory of claim 13, wherein the piece of protective material is adapted to seize up a chainsaw blade upon the blade coming into contact with the piece of protective material.

15. The protective accessory of claim 13, wherein the piece of protective material is attached to the piece of fireproof material so that it protects a thigh portion of the leg of the turnout pants when the piece of fireproof material is attached to the turnout pants.

16. The protective accessory of claim 13, further comprising a second piece of protective material that is attached to the piece of fireproof material so that it protects a shin portion of the leg when the piece of fireproof material is attached to the turnout pants.

17. The protective accessory of claim 13, wherein the piece of protective material extends approximately 180° around the circumference of the leg.

18. A method of altering turnout pants to protect a wearer from a chainsaw, comprising:
positioning a piece of protective material adjacent a portion of a leg of the turnout pants;
positioning a piece of fireproof material on top of the piece of protective material; and
attaching the piece of fireproof material to the leg.

19. The method of claim 18, further comprising attaching a knee pad to an outside surface of the piece of fireproof material.

20. The method of claim 18, further comprising positioning a second piece of protective material adjacent a shin portion of the leg of the turnout pants.
